(19) United States
(12) Patent Application Publication
(10) Pub. No.: US 2003/0131691 A1
(43) Pub. Date: Jul. 17, 2003

(54) Compact hydraulic torque wrench and reaction arm

(75) Inventor: Steven E. Spirer, Washington Township, NJ (US)

Correspondence Address: WEINGRAM & ASSOCIATES P.C., P.O. BOX 927, MAYWOOD, NJ, 07607, US

(73) Assignee: NORWOLF TOOL WORKS

(21) Appl. No.: 10/175,524

(22) Filed: Jun. 19, 2002

Related U.S. Application Data
(60) Provisional application No. 60/299,534, filed on Jun. 20, 2001.

(51) Int. Cl. B25B 13/46

(52) U.S. Cl. 81/57.39

(57) ABSTRACT

A compact hydraulic torque wrench which has an efficient design enabling it to be relatively small in size. The arrangement of the return spring for the hydraulic cylinder provides increased strength and reduces the size of the unit. The device is constructed to enable the drive arm to go through the entire travel without change in alignment. Additionally, the device includes a braking system for the reaction arm to ensure that a ratcheting effect occurs and that the proper return of the hydraulic piston can be accomplished by means of a return spring without the necessity for a hydraulic return of the piston.

CROSS REFERENCE TO RELATED APPLICATION

This application is based upon and claims the benefit of provisional application No. 60/299,534 filed Jun. 20, 2001. The entire contents of this provisional application are incorporated herein by reference.

### FIELD OF THE INVENTION

The present invention relates to power tools and particularly to hydraulic torque wrenches.

### BACKGROUND OF THE INVENTION

Hydraulic torque wrenches are often large and awkward to use. They are difficult to reach into small places, they are heavy, and they are relatively complex devices.

Additionally, the device often will hang up, and will not operate because of misalignment of the piston due to changes in the angle of the drive arm as the wrench goes through THE cycle of travel.

### OBJECTS AND SUMMARY OF THE INVENTION

The present invention sets forth a compact hydraulic torque wrench which has an efficient design enabling it to be relatively small in size. The arrangement of the return spring for the hydraulic cylinder provides increased strength which reduces the size of the unit. The device is constructed in such a way to enable the drive arm go through its entire travel without change in alignment.

Additionally, the device includes a braking system for the reaction arm to ensure that a ratcheting effect occurs and that the proper return of the hydraulic piston can be accomplished by means of a return spring without the necessity for a hydraulic return of the piston.

Accordingly, it is an object of the present invention to provide a compact hydraulic torque wrench in which the return spring is disposed within the piston to reduce the length and diameter required for the piston assembly.

It is another object of the present invention to provide a compact hydraulic torque wrench in which the return spring can be heavier than normal return springs because of its disposition within the piston rather than encircling the piston.

It is another object of the present invention to provide a compact hydraulic torque wrench which does not produce any side loads on the piston during the normal travel of the piston.

It is another object of the present invention to provide a compact hydraulic torque wrench in which the piston is guided throughout its entire length of travel.

It is another object of the present invention to provide a compact hydraulic torque wrench in which the pitch angle of the drive arm never changes as the arm moves along its entire path of travel.

It is another object of the present invention to provide a compact hydraulic torque wrench which can have access to the hydraulic cylinder from either the top or the front.

Another object of the present invention to provide a compact hydraulic torque wrench which has provisions for a reaction arm to fit within the housing to provide a wide flexibility of operation for the wrench.

It is still another object of the present invention is to provide a compact hydraulic torque wrench which has a brake system from which is enabled the braking of the hydraulic arm to overcome the ratchet action in the drive arm.

Other objects of the present invention are to provide a compact hydraulic torque wrench is relatively small in size, relatively light, which has relatively few moving parts, which is relatively simple to manufacture, which is relatively durable, which is relatively inexpensive to produce and which is relatively flexible and easy to use.

### BRIEF DESCRIPTION OF THE DRAWINGS

For a more complete understanding of the present invention reference may be had to the following drawing taken in connection with the description of the preferred embodiments, of which:

FIG. 1 is a side view drawing of a compact torque wrench of the current invention.

FIG. 2 is a rear view drawing of the torque wrench shown in FIG. 1.

FIG. 3 is a top view drawing of the torque wrench shown in FIG. 1 showing the housing only.

FIG. 4 is an exploded view of the components of a compact torque wrench built in accordance with the teachings of the current invention but of slightly different embodiment with respect to the mounting of the closure plate on the back of the housing.

FIG. 5 is a perspective view of the housing from the rear showing the arms of the housing and the holes for the output drive.

FIG. 6 is a rear perspective view of the housing showing the cylinder and the step in the cylinder for coaction with the piston to limit the travel of the piston.

FIG. 7 is a view showing the components of the piston and return spring, the drive arm and the output drive and the braking mechanism for the output drive mounted to the housing.

FIG. 8 is a perspective view showing the piston, the piston arms, the spring guide cylinder within the piston, and the seal at the front of the piston.

FIG. 9 is a view of the piston showing the return spring in the spring guide cylinder of the piston and showing the drive arm mounted within the arms of the piston, with the output drive mounted in the drive arm.

FIG. 10 is a perspective view of the drive arm showing the elongated slots for mounting to the piston and showing the output drive ratchet in place and also showing the passage in the drive arm for a set screw in the output ratchet gear socket.

FIG. 11 shows an access hole at the bottom of the output arm which is used to gain access to the set screw mounted in the output ratchet gear so that a wrench rod can be placed into the socket to make a positive wrench as well as a socket.

FIG. 12 shows the orientation of the brake assembly with the output drive gear.

FIG. 13 is a perspective view from the lower rear of the hydraulic torque wrench of the present invention with the drive arm positioned on the right.

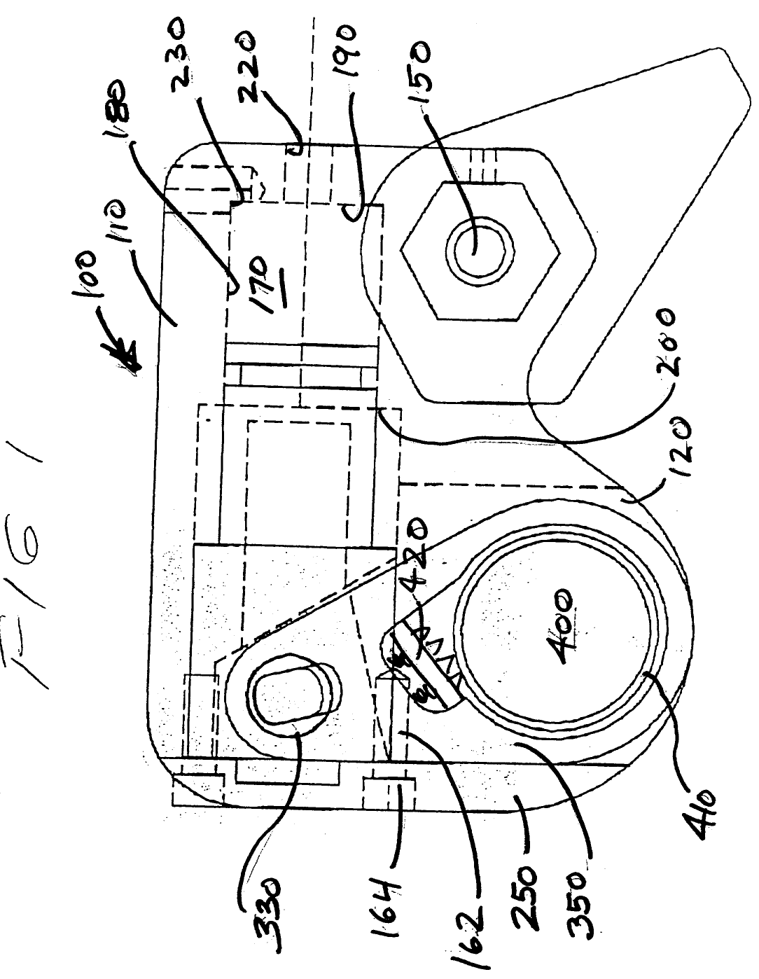

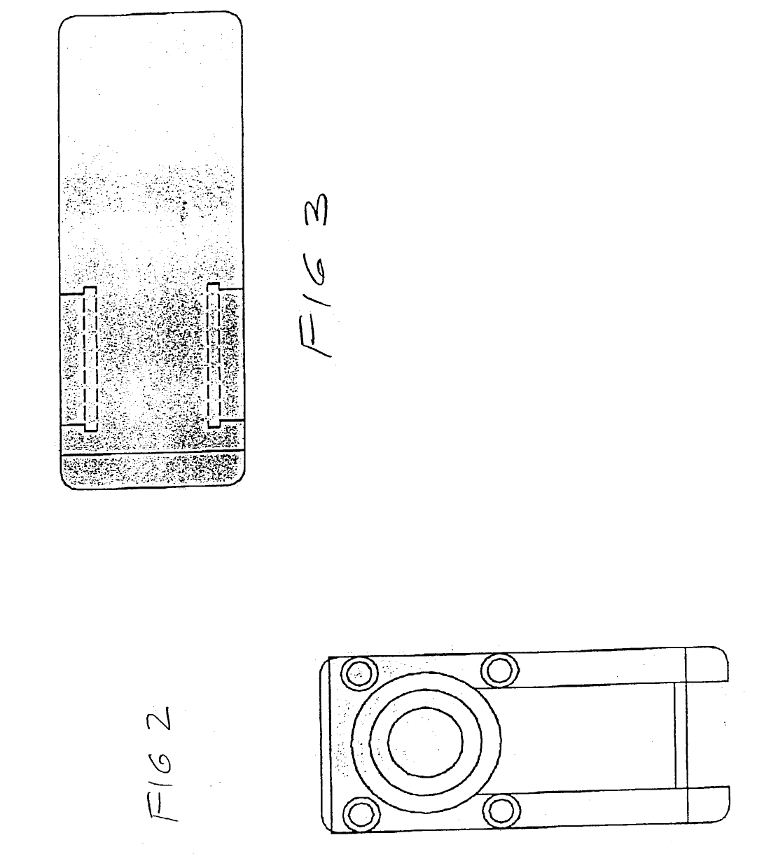

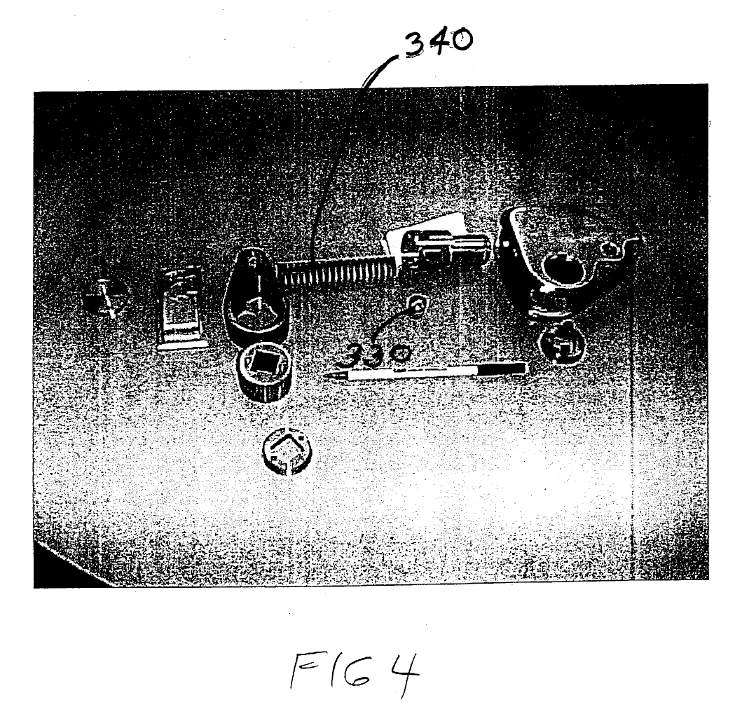

### DETAILED DESCRIPTION OF THE PREFERRED EMBODIMENTS

Glossary of Terms

a) 100 hydraulic torque wrench general

b) 110 housing

i) 120 side arms

130 aperture for the output drive

140 lip for mounting the clutch system

150 aperture for reaction arm

160 keyway for mounting back wall of housing

162 threaded passages in side arms as alternative

164 stress securing back wall to housing

ii) 170 cylinder

180 walls

190 end

200 shoulder

iii) Inlets

220 front inlet

230 top inlet

240 hydraulic connection

iv) 250 back wall of housing

260 closure of pressure plate for back wall of housing

270 recess for seating spring

c) 260 piston

i) 270 shaft

280 top surface

290 seal

300 spring guide shaft or cylinder within the piston

ii) 310 arms

iii) 320 apertures for piston pins

210 piston

iv) 330 piston pins

d) 340 return spring

e) 350 output arm or output plate

i) 360 wings of output plate

362 elongated slots

ii) 370 circular opening for output drive gear

iii) 380 opening for mounting pawl

iv) 390 access opening for set screw in output drive

f) 400 output drive

i) 410 ratchet gear

ii) 420 pawl in output arm

iii) 430 threaded passages for cover screws

iv) 440 cover for ratchet gear

450 brake assembly for ratchet gear

452 O ring in cover for ratchet

454 screw in cover for squeezing O ring against lip 140

v) 460 set screw to hold output socket or output wrench

vi) 470 output socket

vii) 480 output wrench (alternate)

g) 490 reaction arm

h) 500 foot of reaction arm

With reference to the drawings, we can see that the torque wrench has a housing with side arms and passages for mounting the output drive gear. The housing has a cylinder inside it which is used for guiding and coacting with the piston and the cylinder walls have a step in them which coacts with a step in the piston to limit the travel forward of the piston. There are multiple inlets at the front of the housing, one from the front and one from the top so that hydraulic connections can be made either from the top or the front to increase the flexibility of the device by allowing it to be used in various locations and attitudes which would not normally be possible because of the hydraulic input lines.

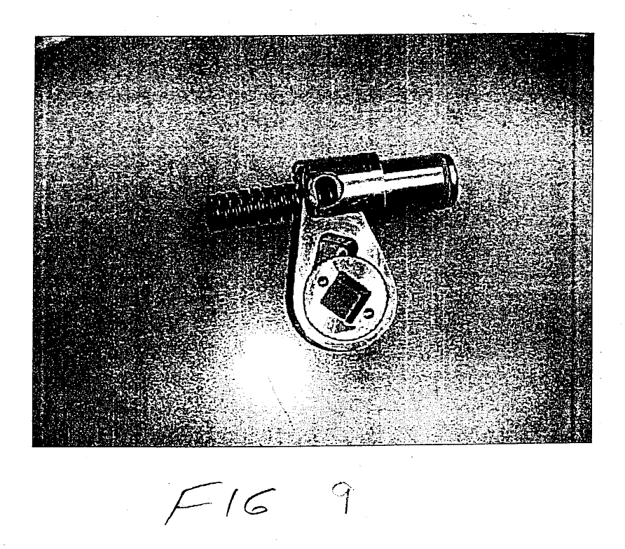

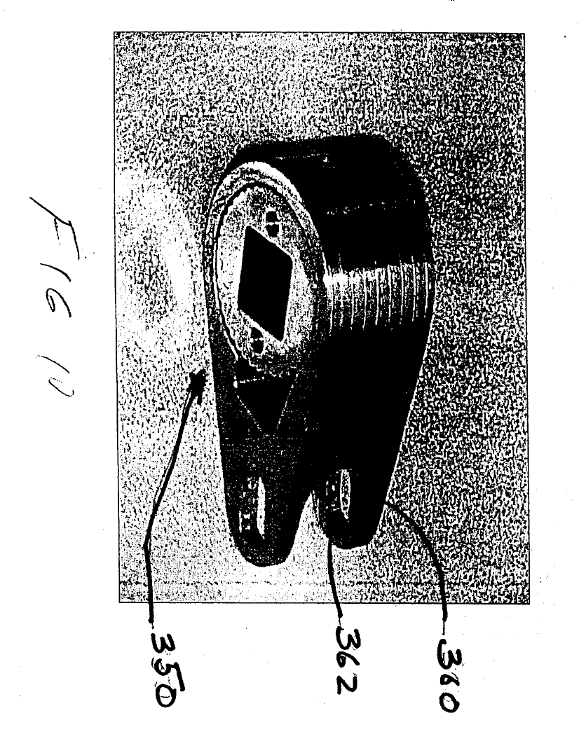

The piston has a conventional top surface and a shaft with a seal mounted on it. The piston shaft which then opens up into two arms as can be seen in FIG. 8. It also shows that there is a spring guide shaft cylinder within the piston shaft to accommodate the return spring. This enables the return spring to be thicker, and stronger and occupy much less room then the usual return spring for a piston. Normally the return spring would have to be wound around the outside of the piston shaft where it would have to have a larger area for dead ending the piston and would take up substantially more room. Here, the spring fits inside the piston spring guide cylinder and the other end acts against the back wall of the housing. The arrangement of the spring in the piston shaft with the output arm is shown best in FIG. 9.

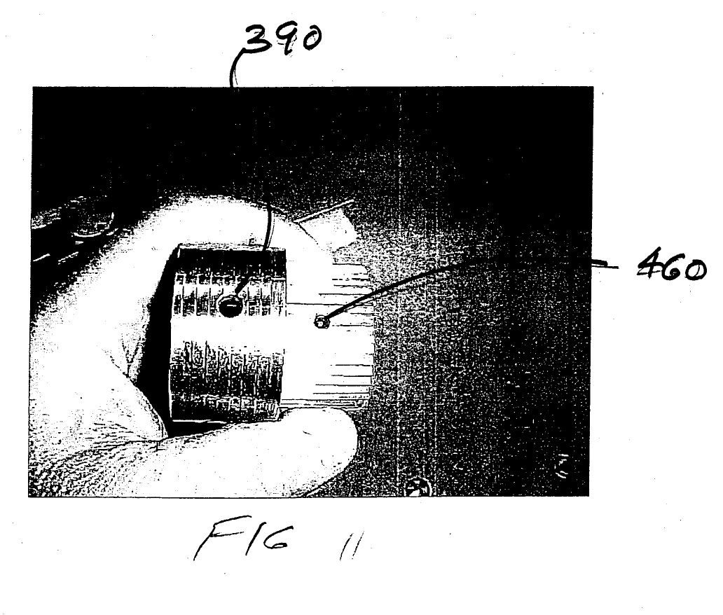

Note that the output arm as shown in FIG. 10 has elongated slots at the upper end for joining to the piston so that movement of the output arm as the piston moves backward in its travel will not produce a force tending to cock the piston. Instead the arm itself will be able to slide relative to the piston, so the piston will always be working without interfering with the cylinder wall or housing.

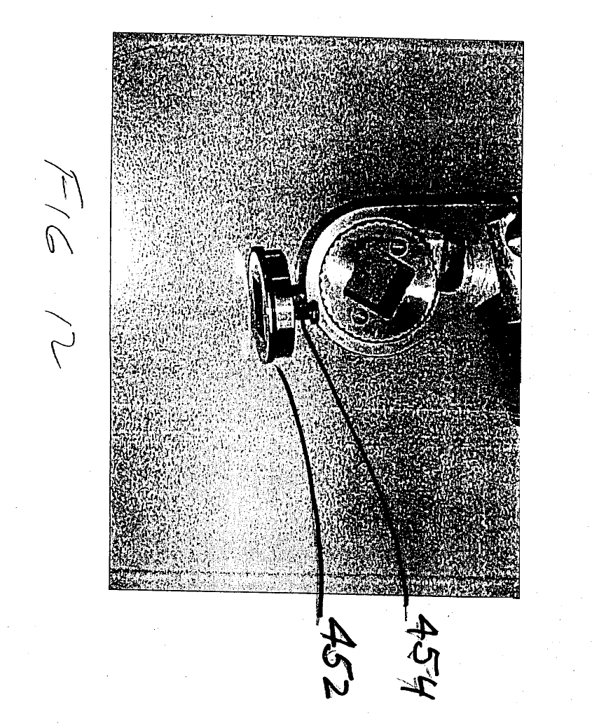

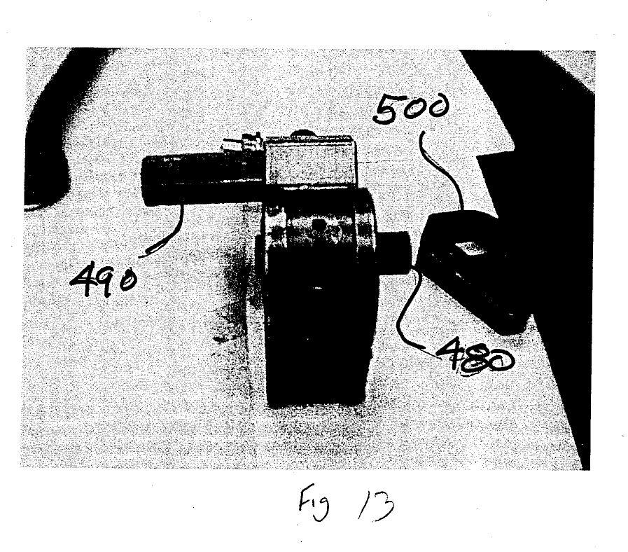

The output drive arm or output plate as shown in FIGS. 9 and 12 is provided with an output drive which has a ratchet gear with a square socket opening or which can have a square piece of stock put into the socket and held by a set screw shown in FIGS. 11 and 13. Access to the set screw is through the passage hole in the bottom of the output arm.

When the hydraulic fluid is placed into the assembled hydraulic torque wrench, the piston will move back against the action of the spring. As it moves back, the change in height of the output arm will be compensated for by the slots in the top of the arm. The output drive will rotate with the action arm because the pawl will hold it stationary with respect to the output arm as the output arm rotates.

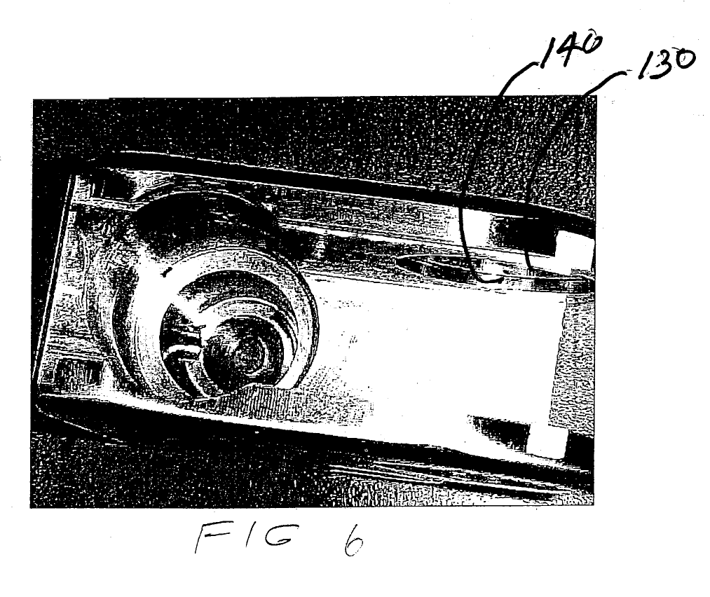

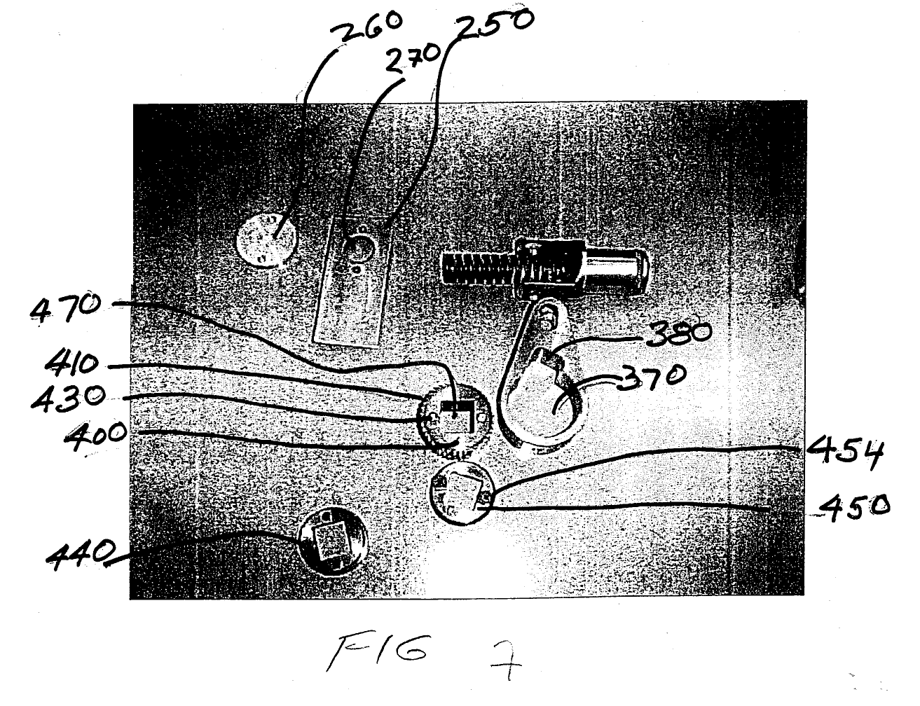

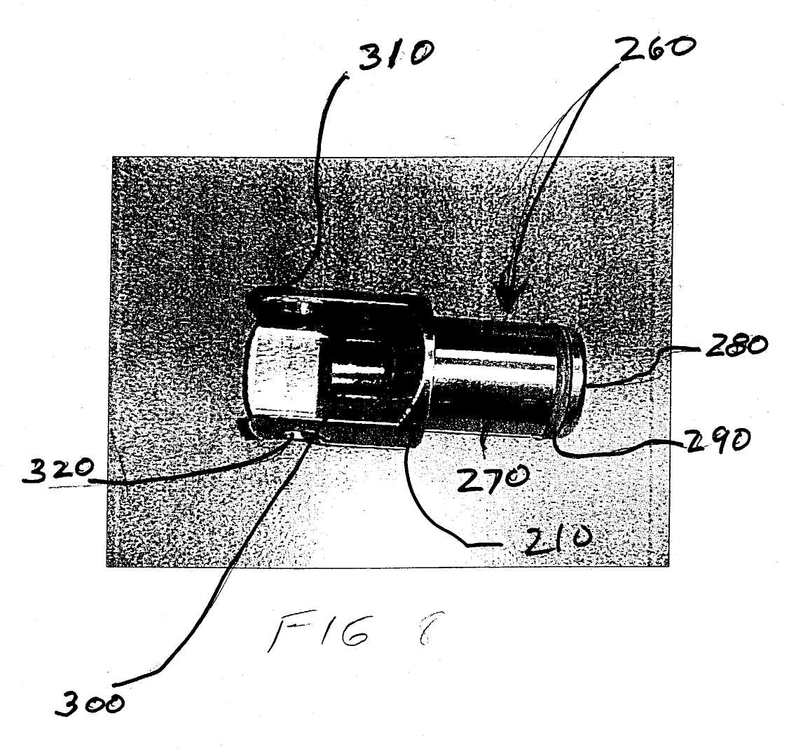

When the output arm reaches the end of its travel as determined by the ramp in the piston, the hydraulic pressure will be released and the spring will act to return the piston to its initial starting position. The pawl will allow the output ratchet gear to slide. The cover for the output gear as shown in FIG. 12 will be mounted so that the O-ring is within the housing and will coact with the lip of the aperture in the housing arm shown in FIG. 5 to act as a braking system to prevent too rapid a return of the arm. The braking force can be adjusted by means of adjusting the screws as shown in FIG. 12 which will then squeeze the O-ring appropriately against the housing as the output gear rotates.

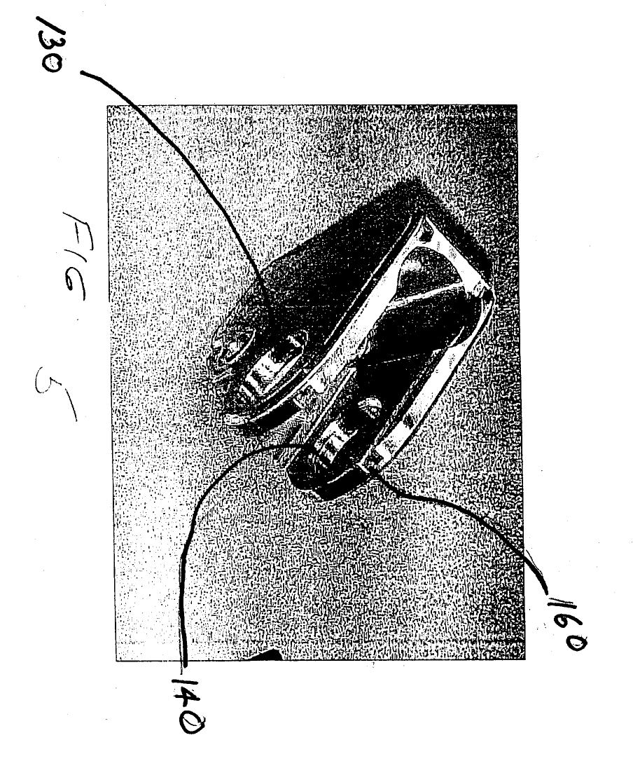

As shown in FIG. 4 there is also a cover for the other side of the output ratchet gear.

More specifically, the elements and coaction of the invention can be described as follows.

As shown in the figures, the hydraulic torque wrench of the present invention comprises as generally indicated at 100 and comprises a housing 110 having a front end and having side arms 120. Apertures 130 exist in the side arms for mounting of an output drive. The apertures 130 have a lip 140 for mounting of a clutch or braking system which will be used to control the movement of the reaction arm. There is an aperture 150 in the front of the housing which is used for mounting of a reaction arm.

A keyway 160 is formed in the rear arms of the housing for a rear wall to be slid into place to close the housing. Alternatively, threaded passages can be formed in the rear of the arms of the housing and the back wall. Threaded passages being designated at 162 which can then be used to secure the back wall to close the housing. A cylinder 170 is formed within the formed the housing cylindrical wall 180 and a forward end 190. A shoulder 200 opens the cylinder to the rear of the housing.

Hydraulic inlets 220 on the front and 230 on the top provide access to hydraulic fluid to the cylinder.

The back wall of the housing 250 has a closure 260 for the back wall of the housing which covers a recess 270 which forms a seat for a return spring 340. A piston 260 is located within the cylinder of the housing. It is has an end or top surface 280 and an external piston seal along its outside surface. The piston has a spring guide shaft 300 machined inside the piston for positioning of a return spring to act against movement of the piston. The piston also has arms 310 which extend rearward from the forward part of the piston and are positioned so as not to interfere with the projection of the shaft 270 so that the return spring 340 can extend from within the shaft to the rear of the housing. The arms of the piston have apertures 320 in which piston pins will be placed to register with elongated slots 362 in arms 360 of an output plate 350 which will respond to the movement of the piston. The elongated slots allow the piston to move horizontally and to pivot the output plate without placing a non-axial stress on the piston. In other words, the piston will not be cocked as it moves rearward because of the coaction between the slots in one of the either piston arms or the arms of the output plate.

The return spring 340 extends into the shaft of the piston and into the recess 270 in the back wall 250 of the housing. The output plate 350 has a circular opening 370 located in the bottom on the plate and an opening 380 for mounting of a pawl which will coact with a ratchet gear 410 formed on the circumference of an output drive 400 which is seated in the opening of the output plate 370.

The output drive has threaded passages for screws to mount the cover of the output drive so that the drive will remain within the output plate. A brake assembly for the output drive is formed by an O ring positioned in the cover for the output drive which then coacts with the lip in the aperture of the housing so that tightening screws 454 will cause the cover 440 to squeeze the O ring against the lip and therefore retard the action of the output drive relative to the output plate.

An output socket can be formed in the output drive as indicated 470. Alternatively, an output wrench 480 can be inserted into the output drive. A reaction arm 490 is positioned within the aperture in the housing 150, and a foot 500 can be placed on the reaction arm.

From the above, it can be seen that the invention described above is a highly compact efficient, relatively lightweight, extremely versatile, compact torque wrench. Structural features of the design provide many novel advantages.

While the invention has been described in its preferred embodiment, it is to be understood that the same is intended to be descriptive and not limiting and that changes may be made within the purview of the invention without departing from the true scope and spirit thereof.

What is claimed is

1. A hydraulic torque wrench comprising:
a housing, comprising:
a front portion,
side arms extending from the front portion,
the side arms having an aperture for an output drive;
the aperture having a lip for mounting a clutch system,
an aperture adapted to receive a reaction arm.
Means for mounting a back wall to the housing:
A cylinder in the housing having
a front end,
walls, and
a shoulder opening to form the end of the cylinder.
a front inlet and a top inlet communicating with the housing cylinder adapted to receive hydraulic connections;
a back wall connected to the wings and rear of the housing,
a closure plate for the back wall of the housing.
The back wall of the housing having a recess adapted for seating of a spring.
A piston comprising:
a shaft with a top surface,
a seal disposed on the outer surface of the shaft, and
A cylinder formed in the shaft of the piston adapted to receive a spring;
the piston having arms extending rearward from the cylinder portion of the piston and spaced to allow passage of a spring disposed in the shaft past the arms of the piston;
apertures disposed in the arms for mounting of piston pins;
a return spring disposed in the spring guide shaft within the piston;
an output plate disposed in the housing;
wings extending from the top of the output plate and extending to the height of the arms of the piston;
elongated slots formed in the wings of the output plate in registration with the apertures in the arms of the piston;
piston pins extending through the apertures in the arms of the piston and through the elongated slots of the wings of the output plate;
a circular opening for an output drive gear formed in the output plate; and
An opening in the output plate for mounting a pawl an access opening in the drive plate for securing an output drive in the circular opening of the output drive gear;
an output drive in the aperture of the circular opening of the output plate,
a ratchet gear formed on the circumference of the output drive.
a pawl mounted in the opening for the pawl in the output plate;
a cover for the ratchet gear adapted to hold the output drive in the output plate.
A brake assembly for the ratchet gear comprising:
an O ring in the cover of the ratchet gear;
and screw means threadably connected to the cover the ratchet gear and extending into threaded passages in the output drive to enable tightening of the cover against the O ring and the the lip of the side arms of the housing; and
hydraulic inlets in the cylinder of the housing to allow pressurized hydraulic fluid into the cylinder,
the hydraulic fluid to act upon the end of the piston to force the piston towards the rear of the housing against the action of the return spring, the rearward movement of the piston will then cause the piston pins to pivot the output plate connected to the piston, with the elongated slots in the output plate allowing the piston to move rearward along the axis of the piston and cause the output plate to rotate as the piston moves rearward until the end of the output plate coacts with the ramp of the piston to or can no longer overcome the force of the spring; the output plate connected to the output drive by means of the ratchet gear and pawl disposed in the output plate; and rotated with the rearward movement of the output plate, and upon relaxing of the hydraulic fluid will allow the spring to act against the rear wall of the housing and the front end of the spring guide shaft in the piston to urge the piston forward.

2. A hydraulic torque wrench comprising:
a housing,
an aperture in the housing for mounting an output plate,
a back wall mounted on the housing,
a cylinder formed in the housing having a front end, a cylindrical wall, and a rear opening.
A piston disposed in the cylinder,
a spring guide shaft in the piston,
a return spring disposed in the spring guide shaft of the piston and coacting with the housing,
an output plate pivotally connected to the piston,
an output drive connected to the output plate,
inlet means in the cylinder to allow intake of pressurized fluid to move the piston and pivot the output plate against the force of the return spring.

3. The hydraulic torque wrench according to claim 2, further comprising:
seal means disposed in the outer wall of the piston.

4. The hydraulic torque wrench claimed in claim 2, further comprising:
ramp means formed on the piston to coact with the output plate to limit travel of the piston.

5. The hydraulic torque wrench claimed in claim 4 further comprising:
the output drive being a circular cylinder,
a ratchet gear formed on the circumference of the output drive,
pawl means disposed in the output plate to coact with the ratchet gear to enable rotation of the output drive in one direction and movement in the other direction without rotation.

6. The hydraulic torque wrench as claimed in claim 1 further comprising:
braking apparatus to control movement of the output drive relative to the output plate comprising:
cover means for the output drive,
an aperture formed in the output plate for receiving the output drive,
a lip in the aperture of the output plate;
O ring means disposed on the cover of the output drive;
threaded passage means in the cover of the output drive and in the output drive; and
threaded means connecting the threaded passages in the output drive and the cover of the output drive to force the cover of the output drive to squeeze the O ring against the lip of the aperture of the output plate.

7. The hydraulic torque wrench of claim 2 further comprising:
seating means on the back wall of the housing for seating of the return spring.

8. The reaction arm of claim 2 wherein the housing includes aperture means for positioning of a reaction arm.

9. The hydraulic torque wrench of claim 2 further comprising:
hydraulic inlet means on two surfaces of the housing perpendicular to each other to enable hydraulic fluid to be injected into the cylinder within the housing from either of the two perpendicular surfaces.

10. The hydraulic torque wrench of claim 2 wherein the rear wall of the housing is connected to the rear of the housing by means of threaded fasteners.

11. A hydraulic torque wrench as defined by claims herein and the equivalents of the claims as set forth herein.
